(19) United States
(12) Patent Application Publication
(10) Pub. No.: US 2025/0097782 A1
(43) Pub. Date: Mar. 20, 2025

(54) DUAL ACTIVE PROTOCOL STACK HANDOVER

(71) Applicant: Nokia Technologies, Espoo (FI)

(72) Inventors: Srinivasan SELVAGANAPATHY, Bangalore (IN); Ahmad AWADA, Munich (DE); Krzysztof KORDYBACH, Wroclaw (PL)

(21) Appl. No.: 18/290,739

(22) PCT Filed: Aug. 1, 2022
(86) PCT No.: PCT/EP2022/071546

§ 371 Date: Jan. 19, 2024

(30) Foreign Application Priority Data
Aug. 5, 2021 (IN) 202141035292

(51) Int. Cl. H04W 36/00; H04W 74/0833

(52) U.S. Cl. CPC H04W 36/0033; H04W 74/0833

(57) ABSTRACT

An apparatus comprising at least one processor; and at least one memory including computer program code; the at least one memory and the computer program code configured to, with the at least one processor, cause the apparatus to perform: enabling dual active protocol stack, DAPS, handover, comprising: receiving DAPS handover configuration information comprising information indicating one or more bearers that are to be released; and maintaining the one or more bearers during a random-access procedure with a target access node.

### TECHNOLOGICAL FIELD

Embodiments of the present disclosure relate to handover. Some relate to dual active protocol stack, DAPS, handover.

### BACKGROUND

A wireless network comprises a plurality of network nodes including terminal nodes and access nodes. Communication between the terminal nodes and the access nodes is wireless.

In some circumstances, it may be desirable to modify or enhance how dual active protocol stack handover is configured and/or executed in a wireless network.

### BRIEF SUMMARY

According to various, but not necessarily all, embodiments there is provided an apparatus comprising
at least one processor; and
at least one memory including computer program code;
the at least one memory and the computer program code configured to, with the at least one processor, cause the apparatus to perform:
enabling dual active protocol stack, DAPS, handover, comprising:
receiving DAPS handover configuration information comprising information indicating one or more bearers that are to be released; and
maintaining the one or more bearers during a random-access procedure with a target access node.

In some examples, the DAPS handover configuration information comprises an indication that the one or more bearers are to be maintained during the random-access procedure with the target access node.

In some examples, the at least one memory and the computer program code configured to, with the at least one processor, cause the apparatus to perform:
releasing the one or more bearers after the random-access procedure with the target access node is completed.

In some examples, releasing the one or more bearers comprises releasing one or more internal bearer configurations and/or resources and/or stopping transmission and/or reception on the one or more bearers.

In some examples, maintaining the one or more bearers comprises maintaining one or more internal bearer configurations and/or resources and/or receiving and/or transmitting on the one or more bearers.

In some examples, the at least one memory and the computer program code configured to, with the at least one processor, cause the apparatus to perform:
if the DAPS handover fails, continuing transmission and/or reception on the one or more bearers.

In some examples, continuing transmission and/or reception on the one or more bearers comprises maintaining one or more services on the one or more bearers.

According to various, but not necessarily all, embodiments there is provided a method comprising:
enabling dual active protocol stack, DAPS, handover, comprising:
receiving DAPS handover configuration information comprising information indicating one or more bearers that are to be released; and
maintaining the one or more bearers during a random-access procedure with a target access node.

In some examples, the DAPS handover configuration information comprises an indication that the one or more bearers are to be maintained during the random-access procedure with the target access node.

In some examples, the method comprising:
releasing the one or more bearers after the random-access procedure with the target access node is completed.

In some examples, releasing the one or more bearers comprises releasing one or more internal bearer configurations and/or resources and/or stopping transmission and/or reception on the one or more bearers.

In some examples, maintaining the one or more bearers comprises maintaining one or more internal bearer configurations and/or resources and/or receiving and/or transmitting on the one or more bearers.

In some examples, the method comprising:
if the DAPS handover fails, continuing transmission and/or reception on the one or more bearers.

In some examples, continuing transmission and/or reception on the one or more bearers comprises maintaining one or more services on the one or more bearers.

According to various, but not necessarily all, embodiments there is provided a computer program comprising instructions for causing an apparatus to perform at least the following:
enabling dual active protocol stack, DAPS, handover, comprising:
receiving DAPS handover configuration information comprising information indicating one or more bearers that are to be released; and
maintaining the one or more bearers during a random-access procedure with a target access node.

In some examples, the DAPS handover configuration information comprises an indication that the one or more bearers are to be maintained during the random-access procedure with the target access node.

In some examples, the computer program comprising instructions for causing an apparatus to perform:
releasing the one or more bearers after the random-access procedure with the target access node is completed.

In some examples, releasing the one or more bearers comprises releasing one or more internal bearer configurations and/or resources and/or stopping transmission and/or reception on the one or more bearers.

In some examples, maintaining the one or more bearers comprises maintaining one or more internal bearer configurations and/or resources and/or receiving and/or transmitting on the one or more bearers.

In some examples, the computer program comprising instructions for causing an apparatus to perform:
if the DAPS handover fails, continuing transmission and/or reception on the one or more bearers.

In some examples, continuing transmission and/or reception on the one or more bearers comprises maintaining one or more services on the one or more bearers.

According to various, but not necessarily all, embodiments there is provided an apparatus comprising means for:
enabling dual active protocol stack, DAPS, handover, comprising:
receiving DAPS handover configuration information comprising information indicating one or more bearers that are to be released; and
maintaining the one or more bearers during a random-access procedure with a target access node.

In some examples, the DAPS handover configuration information comprises an indication that the one or more bearers are to be maintained during the random-access procedure with the target access node.

In some examples, the means are configured to:
release the one or more bearers after the random-access procedure with the target access node is completed.

In some examples, releasing the one or more bearers comprises releasing one or more internal bearer configurations and/or resources and/or stopping transmission and/or reception on the one or more bearers.

In some examples, maintaining the one or more bearers comprises maintaining one or more internal bearer configurations and/or resources and/or receiving and/or transmitting on the one or more bearers.

In some examples, the means are configured to:
if the DAPS handover fails, continue transmission and/or reception on the one or more bearers.

In some examples, continuing transmission and/or reception on the one or more bearers comprises maintaining one or more services on the one or more bearers.

According to various, but not necessarily all, embodiments there is provided an apparatus comprising
at least one processor; and
at least one memory including computer program code;
the at least one memory and the computer program code configured to, with the at least one processor, cause the apparatus to perform:
supporting dual active protocol stack, DAPS, handover, comprising:
receiving DAPS handover configuration information comprising information indicating one or more bearers that are to be released; and
maintaining the one or more bearers after receipt of the DAPS handover configuration information.

In some examples, the at least one memory and the computer program code configured to, with the at least one processor, cause the apparatus to perform:
maintaining the one or more bearers until an indication of DAPS handover success is received.

In some examples, the at least one memory and the computer program code configured to, with the at least one processor, cause the apparatus to perform:
receiving an indication of DAPS handover success; and
releasing the one or more bearers after receiving the indication.

In some examples, the at least one memory and the computer program code configured to, with the at least one processor, cause the apparatus to perform: determining that delayed bearer release is to be used during a DAPS handover procedure.

In some examples, the at least one memory and the computer program code configured to, with the at least one processor, cause the apparatus to perform:
transmitting a DAPS handover request to a target node, the handover request comprising an indication that delayed bearer release is to be used.

In some examples, the DAPS handover configuration information comprises an indication that the one or more bearers are to be maintained during a random-access procedure between a terminal node and a target access node.

In some examples, the DAPS handover configuration information is received in a handover request acknowledgment, wherein the handover request acknowledgement is received in response to a DAPS handover request.

In some examples, the at least one memory and the computer program code configured to, with the at least one processor, cause the apparatus to perform:
amending the DAPS handover configuration information to include an indication that the one or more bearers are to be maintained during a random-access procedure between a terminal node and a target access node.

In some examples, the at least one memory and the computer program code configured to, with the at least one processor, cause the apparatus to perform:
transmitting the DAPS handover configuration information to at least one terminal node.

According to various, but not necessarily all, embodiments there is provided a method comprising:
supporting dual active protocol stack, DAPS, handover, comprising:
receiving DAPS handover configuration information comprising information indicating one or more bearers that are to be released; and
maintaining the one or more bearers after receipt of the DAPS handover configuration information.

In some examples, the method comprising:
maintaining the one or more bearers until an indication of DAPS handover success is received.

In some examples, the method comprising:
receiving an indication of DAPS handover success; and
releasing the one or more bearers after receiving the indication.

In some examples, the method comprising: determining that delayed bearer release is to be used during a DAPS handover procedure.

In some examples, the method comprising:
transmitting a DAPS handover request to a target node, the handover request comprising an indication that delayed bearer release is to be used.

In some examples, the DAPS handover configuration information comprises an indication that the one or more bearers are to be maintained during a random-access procedure between a terminal node and a target access node.

In some examples, the DAPS handover configuration information is received in a handover request acknowledgment, wherein the handover request acknowledgement is received in response to a DAPS handover request.

In some examples, the method comprising:
amending the DAPS handover configuration information to include an indication that the one or more bearers are to be maintained during a random-access procedure between a terminal node and a target access node.

In some examples, the method comprising:
transmitting the DAPS handover configuration information to at least one terminal node.

According to various, but not necessarily all, embodiments there is provided a computer program comprising instructions for causing an apparatus to perform:
supporting dual active protocol stack, DAPS, handover, comprising:
receiving DAPS handover configuration information comprising information indicating one or more bearers that are to be released; and
maintaining the one or more bearers after receipt of the DAPS handover configuration information.

In some examples, the computer program comprising instructions for causing an apparatus to perform:
maintaining the one or more bearers until an indication of DAPS handover success is received.

In some examples, the computer program comprising instructions for causing an apparatus to perform:
receiving an indication of DAPS handover success; and
releasing the one or more bearers after receiving the indication.

In some examples, the computer program comprising instructions for causing an apparatus to perform: determining that delayed bearer release is to be used during a DAPS handover procedure.

In some examples, the computer program comprising instructions for causing an apparatus to perform:
transmitting a DAPS handover request to a target node, the handover request comprising an indication that delayed bearer release is to be used.

In some examples, the DAPS handover configuration information comprises an indication that the one or more bearers are to be maintained during a random-access procedure between a terminal node and a target access node.

In some examples, the DAPS handover configuration information is received in a handover request acknowledgment, wherein the handover request acknowledgement is received in response to a DAPS handover request.

In some examples, the computer program comprising instructions for causing an apparatus to perform:
amending the DAPS handover configuration information to include an indication that the one or more bearers are to be maintained during a random-access procedure between a terminal node and a target access node.

In some examples, the computer program comprising instructions for causing an apparatus to perform:
transmitting the DAPS handover configuration information to at least one terminal node.

According to various, but not necessarily all, embodiments there is provided an apparatus comprising means for:
supporting dual active protocol stack, DAPS, handover, comprising:
receiving DAPS handover configuration information comprising information indicating one or more bearers that are to be released; and
maintaining the one or more bearers after receipt of the DAPS handover configuration information.

In some examples, the means are configured to:
maintain the one or more bearers until an indication of DAPS handover success is received.

In some examples, the means are configured to:
receive an indication of DAPS handover success; and
release the one or more bearers after receiving the indication.

In some examples, the means are configured to: determine that delayed bearer release is to be used during a DAPS handover procedure.

In some examples, the means are configured to:
transmit a DAPS handover request to a target node, the handover request comprising an indication that delayed bearer release is to be used.

In some examples, the DAPS handover configuration information comprises an indication that the one or more bearers are to be maintained during a random-access procedure between a terminal node and a target access node.

In some examples, the DAPS handover configuration information is received in a handover request acknowledgment, wherein the handover request acknowledgement is received in response to a DAPS handover request.

In some examples, the means are configured to:
amend the DAPS handover configuration information to include an indication that the one or more bearers are to be maintained during a random-access procedure between a terminal node and a target access node.

In some examples, the means are configured to:
transmit the DAPS handover configuration information to at least one terminal node.

According to various, but not necessarily all, embodiments there is provided an apparatus comprising
at least one processor; and
at least one memory including computer program code;
the at least one memory and the computer program code configured to, with the at least one processor, cause the apparatus to perform:
supporting dual active protocol stack, DAPS, handover, comprising:
receiving a DAPS handover request comprising an indication that delayed bearer release is to be used;
determining DAPS handover configuration information comprising information indicating one or more bearers that are to be released and an indication that the one or more bearers are to be maintained during a random-access procedure between a terminal node and a target access node; and
transmitting the DAPS handover configuration information.

In some examples, the at least one memory and the computer program code configured to, with the at least one processor, cause the apparatus to perform:
determining the one or more bearers that are to be released.

In some examples, the at least one memory and the computer program code configured to, with the at least one processor, cause the apparatus to perform:
transmitting an acknowledgement that DAPS handover configuration information is configured for delayed bearer release.

According to various, but not necessarily all, embodiments there is provided a method comprising:
supporting dual active protocol stack, DAPS, handover, comprising:
receiving a DAPS handover request comprising an indication that delayed bearer release is to be used;
determining DAPS handover configuration information comprising information indicating one or more bearers that are to be released and an indication that the one or more bearers are to be maintained during a random-access procedure between a terminal node and a target access node; and
transmitting the DAPS handover configuration information.

In some examples, the method comprising:
determining the one or more bearers that are to be released.

In some examples, the method comprising:
transmitting an acknowledgement that DAPS handover configuration information is configured for delayed bearer release.

According to various, but not necessarily all, embodiments there is provided a computer program comprising instructions for causing an apparatus to perform:
supporting dual active protocol stack, DAPS, handover, comprising:
receiving a DAPS handover request comprising an indication that delayed bearer release is to be used;
determining DAPS handover configuration information comprising information indicating one or more bearers that are to be released and an indication that the one or more bearers are to be maintained during a random-access procedure between a terminal node and a target access node; and
transmitting the DAPS handover configuration information.

In some examples, the computer program comprising instructions for causing an apparatus to perform:
determining the one or more bearers that are to be released.

In some examples, the computer program comprising instructions for causing an apparatus to perform:
transmitting an acknowledgement that DAPS handover configuration information is configured for delayed bearer release.

According to various, but not necessarily all, embodiments there is provided an apparatus comprising means for:
supporting dual active protocol stack, DAPS, handover, comprising:
receiving a DAPS handover request comprising an indication that delayed bearer release is to be used;
determining DAPS handover configuration information comprising information indicating one or more bearers that are to be released and an indication that the one or more bearers are to be maintained during a random-access procedure between a terminal node and a target access node; and
transmitting the DAPS handover configuration information.

In some examples, the means are configured to:
determine the one or more bearers that are to be released.

In some examples, the means are configured to:
transmit an acknowledgement that DAPS handover configuration information is configured for delayed bearer release.

According to various, but not necessarily all, embodiments there is provided an apparatus comprising
at least one processor; and
at least one memory including computer program code;
the at least one memory and the computer program code configured to, with the at least one processor, cause the apparatus at least to perform at least a part of one or more methods disclosed herein.

According to various, but not necessarily all, embodiments there is provided an apparatus comprising means for performing at least part of one or more methods disclosed herein.

According to various, but not necessarily all, embodiments there is provided examples as claimed in the appended claims.

The description of a function and/or action should additionally be considered to also disclose any means suitable for performing that function and/or action.

### BRIEF DESCRIPTION

Some examples will now be described with reference to the accompanying drawings in which:

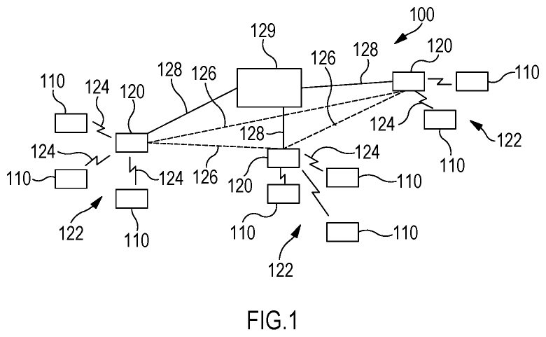

FIG. 1 shows an example of the subject matter described herein;

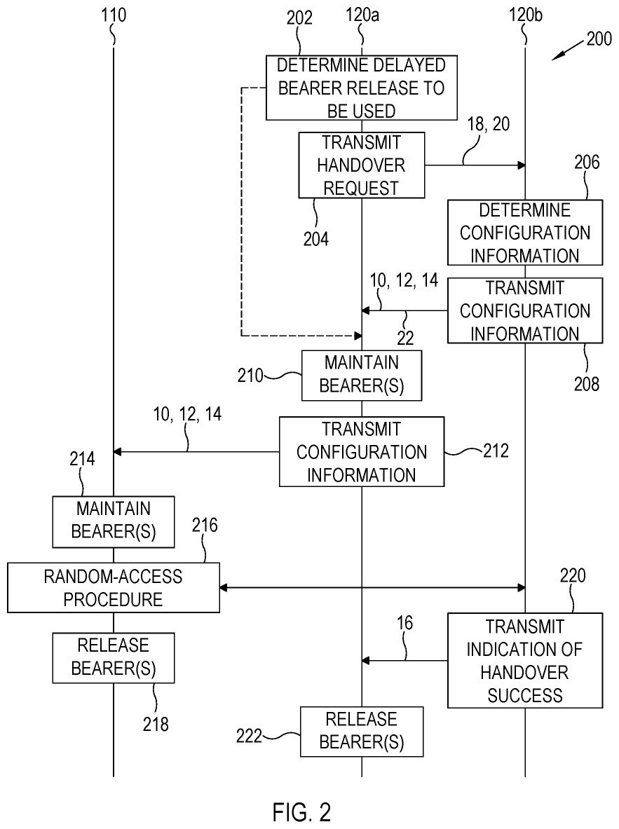

FIG. 2 shows another example of the subject matter described herein;

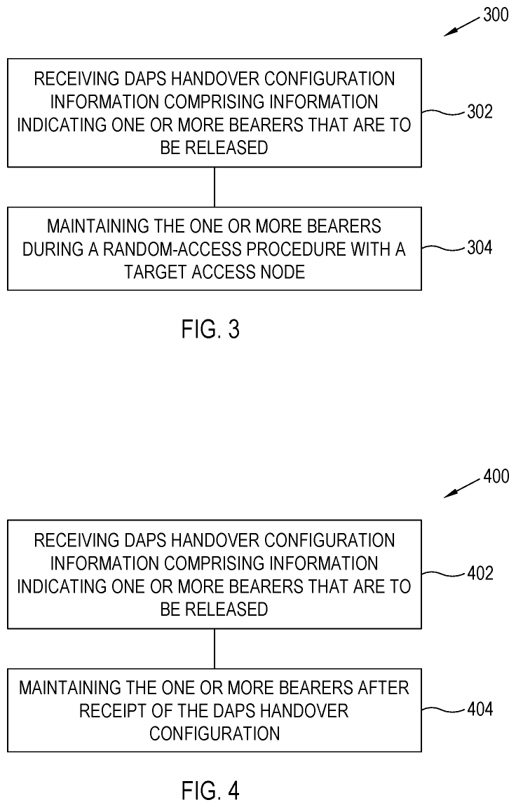

FIG. 3 shows another example of the subject matter described herein;

FIG. 4 shows another example of the subject matter described herein;

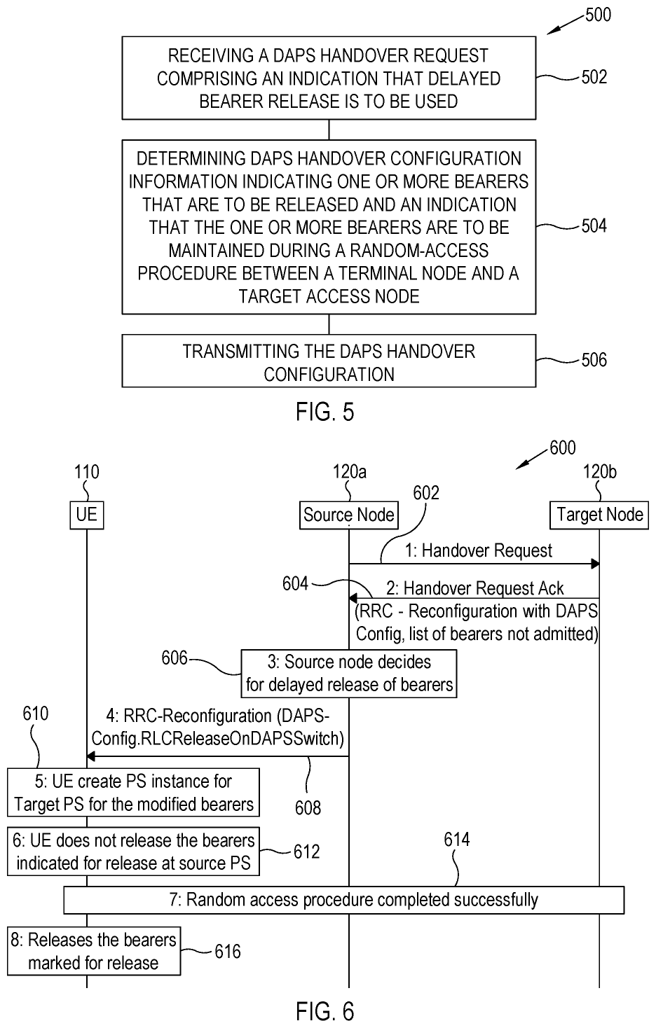

FIG. 5 shows another example of the subject matter described herein;

FIG. 6 shows another example of the subject matter described herein;

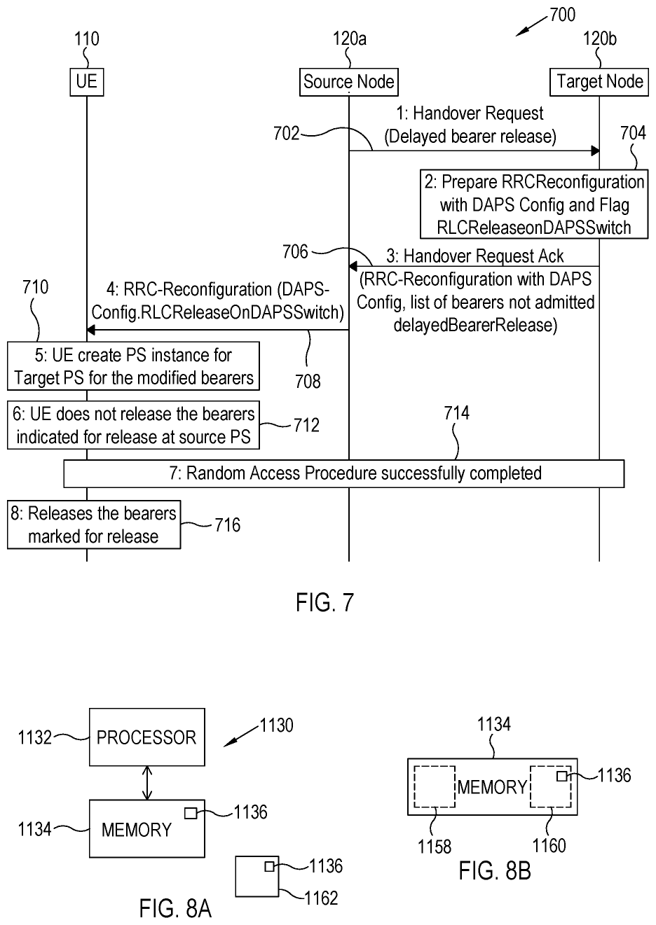

FIG. 7 shows another example of the subject matter described herein;

FIG. 8A shows another example of the subject matter described herein; and

FIG. 8B shows another example of the subject matter described herein.

### ABBREVIATIONS

DAPS—Dual Active Protocol Stack
RRC—Radio Resource Control
RACH—Random Access Channel
CFRA—Contention Free Random Access
RAR—RACH Response
CBRA—Contention Based Random Access
PDCCH—Physical Downlink Control Channel
C-RNTI—Cell Radio Network Temporary Identifier
MAC—Medium Access Control
PDU—Packet Data Unit
CE—Control Element
UL—Uplink
RCL—Radio Link Control
LCH—Logical Channel
3GPP—3rd Generation Partnership Project

### DETAILED DESCRIPTION

FIG. 1 illustrates an example of a network 100 comprising a plurality of network nodes including terminal nodes 110, access nodes 120 and one or more core nodes 129. The terminal nodes 110 and access nodes 120 communicate with each other. The one or more core nodes 129 communicate with the access nodes 120.

The network 100 is in this example a telecommunications network, in which at least some of the terminal nodes 110 and access nodes 120 communicate with each other using transmission/reception of radio waves/signals.

The one or more core nodes 129 may, in some examples, communicate with each other. The one or more access nodes 120 may, in some examples, communicate with each other.

The one or more terminal nodes 110 may, in some examples, communicate with each other.

The network 100 may be a cellular network comprising a plurality of cells 122 at least one served by an access node 120. In this example, the interface between the terminal nodes 110 and an access node 120 defining a cell 122 is a wireless interface 124.

The access node(s) 120 is a cellular radio transceiver. The terminal nodes 110 are cellular radio transceivers.

In the example illustrated the cellular network 100 is a third generation Partnership Project (3GPP) network in which the terminal nodes 110 are user equipment (UE) and the access nodes 120 are base stations (for example, gNBs).

Functionality of a base station may be distributed between a central unit (CU), for example a gNB-CU, and one or more distributed units (DU), for example gNB-DUs.

In the particular example illustrated the network 100 is an Evolved Universal Terrestrial Radio Access network (E-UTRAN). The E-UTRAN consists of E-UTRAN NodeBs (eNBs), providing the E-UTRA user plane and control plane (for example, RRC) protocol terminations towards the UE. The eNBs 120 are interconnected with each other by means of an X2 interface 126. The eNBs are also connected by means of the S1 interface 128 to the Mobility Management Entity (MME) 129.

In other examples the network 100 is a Next Generation (or New Radio, NR) Radio Access network (NG-RAN). The NG-RAN consists of gNodeBs (gNBs), providing the user plane and control plane (for example, RRC) protocol terminations towards the UE. The gNBs are interconnected with each other by means of an X2/Xn interface 126. The gNBs are also connected by means of the N2 interface 128 to the Access and Mobility management Function (AMF).

In examples, the network 100 can comprise a combination of E-UTRAN and NG-RAN.

In examples, a terminal node 110 can be configured to perform and can perform dual active protocol stack handover from a first access node 120a, which can be considered a source node, to a second access node 120b, which can be considered a target node.

Some examples relate to a 3GPP network.

FIG. 2 illustrates an example of a method 200.

In examples, FIG. 2 can be considered to illustrate a plurality of methods. For example, FIG. 2 illustrates one or more actions at a plurality of actors/entities. In examples, FIG. 2 can be considered to illustrate a plurality of methods performed by the individual actors/entities.

One or more of the features discussed in relation to FIG. 2 can be found in one or more of the other FIGs. During discussion of FIG. 2, reference will be made to other FIGs for the purposes of explanation.

In the example of FIG. 2, a plurality of apparatuses transmit and/or receive one or more signals and/or one or more messages across and/or via and/or using a network. In examples, any suitable form of communication in any suitable network can be used. For example, at least a portion of the network 100 of FIG. 1 can be used.

Accordingly, in examples, the plurality of apparatuses in FIG. 2 form at least a portion of a network 100 as described in relation to FIG. 1.

In the illustrated example, a terminal node 110, a first access node 120a and a second access node 120b transmit and/or receive one or more signals and/or one or more messages. In examples, the first access node 120a can be considered a source node and the second access node 120b can be considered a target node.

In examples, communications and/or transmissions between elements illustrated in FIG. 2 can proceed via any number of intervening elements, including no intervening elements.

In examples, method 200 and/or parts of method 200 can be considered a method of enabling dual active protocol stack (DAPS) handover.

In some examples, method 200 and/or parts of method 200 can be considered a method of supporting dual active protocol stack (DAPS) handover.

In some examples, method 200 and/or parts of method 200 can be considered a method of performing dual active protocol stack (DAPS) handover.

In some examples, method 200 and/or parts of method 200 can be considered a method of delaying bearer release during dual active protocol stack (DAPS) handover.

In some examples, method 200 and/or parts of method 200 can be considered a method of enhancing fallback during dual active protocol stack (DAPS) handover.

In the example of FIG. 2 a radio connection is established between the terminal node 110 and the first access node 120a, which can be considered a source node.

In the illustrated example, a DAPS handover is to take place from the first access node 120a to the second access node 120b, which can be considered a target node.

Some, but not necessarily all, examples of the disclosure relate to and/or involve use and/or maintenance and/or release of one or more bearers.

In some, but not necessarily all, examples one or more bearers can be and/or can be considered and/or can comprise one or more radio bearers and/or one or more data bearers.

In examples a bearer can be considered to be and/or to comprise one or more configurations and/or one or more resources to allow an apparatus, for example a terminal node 110 and/or an access node 120, to transmit and/or receive data and/or information of traffic flow identified by the bearer identifier and/or logical channel identifier.

In examples, a bearer can be considered to be and/or to comprise a traffic flow which includes configuration, resources and identifier for bearer traffic logical-channel-ID or bearer-ID given from higher layers to map the packet transmission/reception to these resources and configuration

In examples, one or more configurations can comprise one or more radio configurations and/or one or more internal configurations.

In examples, one or more resources can comprise one or more internal device resources and/or one or more radio resources.

In examples, a bearer can be and/or can be considered to be formed between two entities, for example a terminal node 110 and an access node 120, to allow transmission and/or reception of data and/or information.

In examples, a bearer can support one or more services and/or one or more types of traffic.

In examples, a bearer can be associated with one or more services and/or one or more types of traffic.

In examples, one or more characteristics and/or one or more requirements can be associated with one or more bearers, for example, quality of service, data rate, latency, one or more bearer identifiers such as bearer-ID and logical channel identifiers and so on.

In examples, releasing one or more bearers comprises and/or can be considered to comprise releasing one or more elements of a configured and/or formed and/or established bearer.

In some examples, releasing one or more bearers comprises and/or can be considered to comprise releasing one or more internal bearer configurations and/or resources and/or stopping transmission and/or reception on the one or more bearers.

In some examples, releasing one or more bearers comprises and/or can be considered to comprise releasing the radio link control (RLC) entity or entities as specified in TS 38.322 [4], clause 5.1.3 and/or releasing the corresponding logical channel(s).

In examples, maintaining one or more bearers comprises and/or can be considered to comprise maintaining one or more elements of a configured and/or formed and/or established bearer.

In some examples, maintaining one or more bearers comprises and/or can be considered to comprise maintaining one or more internal bearer configurations and/or resources and/or receiving and/or transmitting on the one or more bearers. For example, maintaining one or more bearers can comprise maintaining the configurations and resources associated with the one or more bearers to allow transmission and/or reception of data and/or information on the one or more bearers.

In some examples, maintaining one or more bearers comprises and/or can be considered to comprise maintaining the radio link control (RLC) entity or entities as specified in TS 38.322 [4], clause 5.1.3 and/or maintaining the corresponding logical channel(s).

At block 202, method 200 comprises determining that delayed bearer release is to be used during a DAPS handover procedure.

In examples, a DAPS handover procedure can be considered a DAPS handover process, a DAPS handover method, a DAPS handover technique and so on.

In the illustrated example, the location of the blocks indicates the entity performing the action(s). For example, in FIG. 2, block 202 is performed at and/or by the first access node 120a, which can be considered a source node.

As used herein, the term “determining” (and grammatical variants thereof) can include, not least: calculating, computing, processing, deriving, investigating, looking up (for example, looking up in a table, a database or another data structure), ascertaining and the like. Also, “determining” can include receiving (for example, receiving information), accessing (for example, accessing data in a memory) and the like. Also, “determining” can include resolving, selecting, choosing, establishing, and the like.

In examples, determining that delayed bearer release is to be used during a DAPS handover procedure can be performed in any suitable way using any suitable information.

In examples, determining that delayed bearer release is to be used during a DAPS handover procedure can comprise determining that delayed release of one or more bearers that cannot be accommodated and/or configured and/or established and/or supported at a target node during a DAPS handover procedure is to be used.

Accordingly, in examples, block 202 can be considered to comprise determining that delayed bearer release is to be used for and/or in relation to one or more bearers that cannot be accommodated and/or configured and/or established and/or supported at a target node during a DAPS handover procedure.

In some but not necessarily all examples reference to delayed bearer release can be considered to refer to delayed release of bearers that cannot be accommodated and/or configured and/or established and/or supported at a target node as a consequence of a handover to the target node.

In some examples, reference to delayed bearer release can be considered reference to maintenance of one or more bearers.

In examples, block 202 can be performed at any suitable time in method 200.

In some examples, block 202 can be performed prior to transmission of a handover request 18 at block 204.

Such examples can be considered proactive examples. See, for example, FIG. 7.

In some examples, block 202 can be performed after the first access node 120a receives DAPS handover configuration information 10 from the second access node 120b. This is illustrated by the dashed line from block 202 in the example of FIG. 2.

For example, in such examples, block 202 can be performed based, at least in part, on the information provided in received DAPS handover configuration information 10, such as an indication that one or more bearers are to be released.

Such examples can be considered reactive examples. See, for example, FIG. 6.

At block 204, method 200 comprises transmitting a DAPS handover request 18.

In the example of FIG. 2 the DAPS handover request 18 is transmitted from the first access node 120a to the second access node 12b. This is illustrated by the arrow pointing from block 204 towards the line representing the second access node 120b.

As FIG. 2 illustrates one or more actions of transmission, FIG. 2 also illustrates the corresponding receiving feature(s)/action(s) and vice versa.

For example, from the point of view of the second access node 120b, block 202 can be considered to illustrate receiving a DAPS handover request 18.

In examples, the DAPS handover request 18 can have any suitable form and can be transmitted in any suitable way. For example, block 204 can comprise transmitting/receiving one or more handover request messages.

In some examples, the DAPS handover request 18 comprises an indication 20 that delayed bearer release is to be used. For example, in examples where block 202 occurs prior to block 204 the DAPS handover request 18 can comprise an indication 20 that delayed bearer release is to be used.

Accordingly, in some examples method 200 comprises transmitting a DAPS handover request 18 to a target node, the handover request 18 comprising an indication 20 that delayed bearer release is to be used.

From the point of view of the second access node 120b, in examples, method 200 comprises receiving a DAPS handover request 18 comprising an indication 20 that delayed bearer release is to be used.

In examples, any suitable indication 20 having any suitable form can be used.

In some examples, any suitable additional information can be comprised and/or included in the handover request 18 to provide the indication 20. For example, one or more flags in the handover request can be used to provide the indication 20.

In some examples the handover request 18 comprises the indication 20, see, for example, FIG. 7, and in some examples the handover request 18 does not comprise the indication 20, see, for example, FIG. 6.

At block 206, method 200 comprises determining DAPS handover configuration information 10 comprising information 12 indicating one or more bearers that are to be released.

In examples, determining DAPS handover configuration information 10 can be performed in any suitable way using any suitable method.

In examples, the DAPS handover configuration information 10 can have any suitable form. For example, the DAPS handover configuration information 10 can have any suitable form to configure and/or control and/or cause a DAPS handover to occur at the terminal node 110.

For example, the DAPS handover configuration information 10 can be configured to be executed by a terminal node 110 to configure and/or control and/or cause a DAPS handover to occur at the terminal node 110.

In examples, the DAPS handover configuration information 10 comprises a DAPS handover configuration.

In some examples, the DAPS handover configuration information 10 can be and/or can comprise and/or can form part of radio reconfiguration information. For example, the DAPS handover configuration information 10 can be and/or can comprise and/or can form part of radio resource control reconfiguration information (RRCReconfiguration information).

Accordingly, in some examples determining DAPS handover configuration information 10 can comprise determining a radio reconfiguration message, for example a RRCReconfiguration message.

In examples, the one or more bearers that are to be released are bearers configured and/or established at the terminal node 110 and/or the first access node 120a and/or between the terminal node 120b and the first access node 120b that cannot be accommodated and/or configured and/or established and/or supported at the second access node 120b.

In examples, method 200 comprises determining the one or more bearers that are to be released. Determining the one or more bearers that are to be released can be performed in any suitable way using any suitable method.

In examples, determining the one or more bearers to be released comprises determining one or more bearers that are to be accommodated and/or configured and/or established and/or supported at the second access node 120b as a consequence of the DAPS handover and determining which of those bearers, if any, the second access node 120b cannot accommodate and/or configure and/or establish and/or support.

In examples, one or more bearers cannot be accommodated and/or configured and/or established and/or supported at/by the second access node 120b for any suitable reason.

For example, the second access node 120b does not, in some examples, have and/or cannot afford the resources to accommodate the one or more bearers and/or cannot accommodate and/or meet and/or support the traffic type and/or associated characteristic(s) and/or requirement(s) of the one or more bearers.

In examples, the information 12 indicating the one or more bearers to be released can have any suitable form.

In some examples the indication comprises a list indicating the one or more bearers to be released.

In examples the list can be specified in ‘rlc-BearerToReleaseList’.

In some examples, the DAPS handover configuration information 10 comprises an indication 14 that the one or more bearers are to be maintained during a random-access procedure between a terminal node 110 and a target access node 120b.

Accordingly, in some examples, block 206 comprises determining DAPS handover configuration information 10 comprising information 12 indicating one or more bearers that are to be released and an indication 14 that the one or more bearers are to be maintained during a random-access procedure between a terminal node 110 and a target access node 120b.

For example, in examples where block 202 occurs prior to block 204 the DAPS handover configuration information 10 can comprise an indication 14 that the one or more bearers are to be maintained during a random-access procedure between a terminal node 110 and a target access node 120b. See, for example, FIG. 7.

However, in some examples, the DAPS handover configuration information 10 does not comprise the indication 14 that one or more bearers are to be maintained during a random-access procedure between a terminal node 110 and a target access node 120b. See, for example, FIG. 6.

In examples, the indication 14 that one or more bearers are to be maintained during a random-access procedure between a terminal node 110 and a target access node 120b can have any suitable form.

For example, any suitable additional information can be comprised and/or included in the DAPS handover configuration information 10 to provide the indication 14. In examples, one or more flags in the DAPS handover configuration information can be used to provide the indication 14.

In examples a flag ‘RLCReleaseonDAPSSwitch’ can be used to provide the indication 14 that one or more bearers are to be maintained during a random-access procedure between a terminal node 110 and a target access node 120b.

In examples, the indication 14, such as a flag ‘RLCReleaseonDAPSSwitch’, indicates that the terminal node, such as a UE, should release the logical channel entities specified in ‘rlc-BearerToReleaseList’ after successful random access (UL switch) if DAPS bearer is configured.

In some examples the DAPS handover configuration information 10 comprises an indication 14 that one or more bearers are to be maintained during a random-access procedure between a terminal node 110 and a target access node 120b, see, for example, FIG. 7, and in some examples the DAPS handover configuration information 10 does not comprise the indication 14, see, for example, FIG. 6.

In some examples, separate indications 14 can be provided for individual bearers in the information 12 indicating one or more bearers that are to be released.

For example, a separate flag can be provided in relation to the different bearers of the one or more bearers indicating whether or not the different bearers are to be maintained during a random-access procedure between a terminal node 110 and a target access node 120b.

That is, in some examples, an indication 14 can be provided for each of the one or more bearers and can be specific for each of the one or more bearers identified by the second access node 120b.

For example, a flag indicating ‘1’ can be used to indicate that the bearer is to be maintained and a flag indicating ‘0’ can be used to indicate that the bearer is not to be maintained/can be released.

In some examples, the first access node 120a can identify and inform the second access node 120b of a list of bearers that will be maintained by the first access node 120a and terminal node 110, for example until UL switch, in case they are released by the second access node 120b.

At block 208, method 200 comprises transmitting the DAPS handover configuration information 10. In the example of FIG. 2 the DAPS handover configuration information 10 is transmitted to/received by the first access node 120a, which can be considered a source node.

In examples, transmitting the DAPS handover configuration information 10 can be performed in any suitable way using any suitable method.

In examples, transmitting the DAPS handover configuration information 10 comprises transmitting a radio reconfiguration message, for example a RRCReconfiguration message.

In some examples, transmitting/receiving the DAPS handover configuration information 10 comprises transmitting/receiving a handover request acknowledgement in response to the DAPS handover request 18.

That is, in some examples, method 200 comprises transmitting/receiving a handover request acknowledgement in response to the DAPS handover request 18, the handover request acknowledgement comprising DAPS handover configuration information 10.

Accordingly, in some examples, the DAPS handover configuration information 10 is received in a handover request acknowledgment, wherein the handover request acknowledgement is received in response to a DAPS handover request 18.

In some examples the transmitted/received DAPS handover configuration information 10 comprises an indication 14 that the one or more bearers are to be maintained during a random-access procedure between a terminal node 110 and a target access node 120b. See, for example, FIG. 7.

Consequently, according to some examples, FIG. 2 illustrates a method 200 comprising:
supporting dual active protocol stack, DAPS, handover, comprising:
receiving a DAPS handover request 18 comprising an indication 20 that delayed bearer release is to be used;
determining DAPS handover configuration information 10 comprising information 12 indicating one or more bearers that are to be released and an indication 14 that the one or more bearers are to be maintained during a random-access procedure between a terminal node 110 and a target access node 120b; and
transmitting the DAPS handover configuration information 10.

In some examples, the transmitted/received DAPS handover configuration information 10 does not comprise an indication 14 that the one or more bearers are to be maintained during a random-access procedure between a terminal node 110 and a target access node 120b. See, for example, FIG. 6.

For example, in some examples where block 202 is performed after the first access node 120a, or source node, receives the DAPS handover configuration information 10 from the second access node 120b, or target node.

In some examples, method 200 comprises, at and/or by the second access node 120b, transmitting an acknowledgement 22 that DAPS handover configuration information 10 is configured for delayed bearer release.

For example, in examples where the handover request 18 comprises an indication 20 that delayed bearer release is to be used the second access node 120b can transmit, to the first access node 120a, an acknowledgement 22 that the DAPS handover configuration information 10 is configured for delayed bearer release.

In examples transmitting an acknowledgement 22 that DAPS handover configuration information 10 is configured for delayed bearer release can be performed in any suitable way using any suitable method.

For example, the acknowledgement 22 can be transmitted as part of a handover request acknowledgement message, such as a Handover-Request-ACK.

In some examples, the acknowledgement 22 can be transmitted with and/or as part of the DAPS handover configuration information 10.

In some examples, the acknowledgement 22 can be transmitted separate from the DAPS handover configuration information 10.

In examples, the acknowledgement 22 can have any suitable form. For example, any suitable information can be added to a handover request acknowledgement message and/or to the DAPS handover configuration information 10 to provide the acknowledgement 22.

In examples, one or more flags can be used to provide the acknowledgement 22. For example, one or more flags in a handover request acknowledgement message can be used to provide the acknowledgement 22.

In some examples a flag ‘delayed-DRB-Release-DAPS-Response’ can be used.

At block 210, method 200 comprises maintaining the one or more bearers after receipt of the DAPS handover configuration information 10.

That is, in examples, the first access node 120a, or source node, maintains the one or more bearers indicated as to be released in the DAPS handover configuration information 10, after receipt of the DAPS handover configuration information 10.

The first access node 120a, or source node, does not, in examples, release the one or more bearers indicated as to be released in the DAPS handover configuration information 10, upon receipt of the DAPS handover configuration information 10.

Consequently, FIG. 2 illustrates a method 200 comprising:
supporting dual active protocol stack, DAPS, handover, comprising:
receiving DAPS handover configuration information 10 comprising information 12 indicating one or more bearers that are to be released; and
maintaining the one or more bearers after receipt of the DAPS handover configuration information 10.

This allows, for example, the first access node 120a, or source node, to continue transmitting and/or receiving data and/or information on the one or more bearers after receipt of the DAPS handover configuration information 10.

In examples, the first access node 120a can maintain the one or more bearers for any suitable length of time.

In some examples, method 200 comprises maintaining the one or more bearers until an indication of DAPS handover success is received. See, for example, blocks 220 and 222 of the example of FIG. 2.

As previously discussed, in some examples, the DAPS handover configuration information 10 does not comprise an indication 14 that the one or more bearers are to be maintained during a random-access procedure between a terminal node 110 and a target access node 120b.

In some such examples, the first access node 120a can amend and/or update and/or change the DAPS handover configuration information 10 to include such an indication 14.

Accordingly, in some examples method 200 comprises amending, by the first access node 120a, the DAPS handover configuration information 10 to include an indication 14 that the one or more bearers are to be maintained during a random-access procedure between a terminal node 110 and a target access node 120b.

At block 212, method 200 comprises transmitting the DAPS handover configuration information 10.

Accordingly, from the point of view of the terminal node 110, block 212 comprises receiving DAPS handover configuration information 10 comprising information 12 indicating one or more bearers to be released.

In examples, transmitting the DAPS handover configuration information 10 can be performed in any suitable way using any suitable method.

In examples, transmitting the DAPS handover configuration information 10 comprises transmitting a radio reconfiguration message, for example a RRCReconfiguration message.

In some examples the DAPS handover configuration 10 transmitted to/received by the terminal node 110 comprises an indication 14 that the one or more bearers are to be maintained during a random-access procedure between a terminal node 110 and a target access node 120b.

In some examples, the DAPS handover configuration information 10 transmitted to/received by the terminal node 110 does not comprise an indication 14 that the one or more bearers are to be maintained during a random-access procedure between a terminal node 110 and a target access node 120b.

In examples, the terminal node 110 acts upon and/or applies the DAPS handover configuration information 10 and initiates a DAPS handover from the first access node 120a, or source node, to the second access node 120b, or target node.

At block 214, method 200 comprises maintaining the one or more bearers after receipt of the DAPS handover configuration information 10.

That is, in examples, the terminal node 110 maintains the one or more bearers indicated as to be released in the DAPS handover configuration information 10, after receipt of the DAPS handover configuration information 10.

The terminal node 110 does not, in examples, release the one or more bearers indicated as to be released in the DAPS handover configuration information 10, upon receipt of the DAPS handover configuration information 10.

In examples, the terminal node 110 can maintain the one or more bearers for any suitable length of time.

In some examples, the terminal node 110 maintains the one or more bearers during the random-access procedure with the target access node 120b.

In some examples, the terminal node 110 maintains the one or more bearers until successful completion of the random-access procedure with the target access node 120b.

In some examples, the terminal node 110 maintains the one or more bearers during radio connection establishment with the target access node 120b.

In some examples, the terminal node 110 maintains the one or more bearers until successful establishment of a radio connection with the target access node 120b.

In some examples, the terminal node 110 maintains the one or more bearers during the handover procedure with the target access node 120b.

In some examples, the terminal node 110 maintains the one or more bearers until successful completion of the handover procedure with the target access node 120b.

In some examples, the terminal node 110 maintains the one or more bearers until uplink switch occurs to the second access node 120b, or target access node.

Consequently, in examples, FIG. 2 illustrates a method 200 comprising: enabling dual active protocol stack, DAPS, handover, comprising:

receiving DAPS handover configuration information 10 comprising information 12 indicating one or more bearers that are to be released; and

maintaining the one or more bearers during a random-access procedure with a target access node 120b.

This allows, for example, the terminal node 110 to continue transmitting and/or receiving data and/or information on the one or more bearers after receipt of the DAPS handover configuration information 10.

In examples, the terminal node 110 continues to receive/transmit user data packets from/to the first access node 120a on the one or more bearers.

In some examples, the terminal node 110 releases the one or more bearers on receiving the DAPS handover configuration information 10. For example, if the terminal node 110 is not configured to and/or does not support maintaining the one or more bearers that are to be released.

At block 216 of method 200 a random-access procedure and/or process is performed between the terminal node 110 and the second access node 120b, which can be considered a target node 120b.

Accordingly, in examples, from the point of view of the terminal node 110 method 200 comprises performing a random-access procedure with the second access node 120b.

Accordingly, in examples, from the point of view of the second access node 120b method 200 comprises performing a random-access procedure with the terminal node 110.

In examples, any suitable random-access procedure can be performed in any suitable way using any suitable method.

In some examples a random-access channel (RACH) process can be used.

In examples the random-access procedure can be contention based or contention free.

In examples, the random-access procedure is successful and the method 200 proceeds to block 218/220. The random-access procedure can be considered successful upon completion of any suitable criterion or criteria.

In case of contention-free random access (CFRA), in examples, the random-access procedure can be considered to be successful when the RACH response (RAR) is received by the terminal node 110.

In case of contention based random access (CBRA), in examples, the random-access procedure can be considered to be successful when the terminal node 110 receives physical downlink control channel (PDCCH) addressed by cell radio network temporary identifier (C-RNTI) scheduling the medium access control (MAC) packet data unit (PDU) containing the terminal node 110 contention resolution MAC control element (CE).

In some examples, a random-access procedure can be considered completed when uplink switch is successfully completed.

At block 218, method 200 comprises releasing the one or more bearers after the random-access procedure with the target access node 120b is completed.

In examples, method 200 comprises releasing, by the terminal node 110, the one or more bearers when it is determined that the one or more bearers are no longer to be maintained as discussed in relation to block 214.

In some examples, if DAPS bearer is configured and rlcbearerReleaseonDAPSSwitch is set and UE has successfully completed the RACH access to target cell, for each logicalChannelldentity value included in the rlc-BearerToReleaseList that is part of the current UE configuration within the same cell group (LCH release),

UE releases the RLC entity or entities as specified in TS 38.322 [4], clause 5.1.3; UE releases the corresponding logical channel.

At block 220, method 200 comprises transmitting, by the second access node 120b, an indication of DAPS handover success 16 to the first access node 120a.

In examples, an indication of DAPS handover success 16 can be transmitted in any suitable way using any suitable method.

In examples any suitable indication 16 of DAPS handover success can be used.

For example, any suitable message indicating handover success can be used.

From the point of view of the first access node 120a, block 220 comprises receiving an indication of DAPS handover success 16.

At block 222, method 200 comprises releasing, by the first access node 120a, the one or more bearers.

Accordingly, in examples, method 200 comprises receiving an indication of DAPS handover success 16 and releasing the one or more bearers after receiving the indication 16.

In some examples, method 200 can be considered to comprise receiving an indication of DAPS handover success 16 and releasing the one or more bearers upon receipt of the indication and/or in response to receiving the indication and/or based, at least in part, on receiving the indication and so on.

In some examples, method 200 can be considered to comprise maintaining the one or more bearers until an indication 16 of DAPS handover success is received.

In some examples, the random-access procedure at block 216 can fail. In such examples, the terminal node 110 and first access node 120a can continue to transmit/receive information on the one or more bearers.

Accordingly, in examples, method 200 comprises if the DAPS handover fails, continuing transmission and/or reception on the one or more bearers.

That is, in case of fallback, the terminal node 110 and the first access node 120a continue transmission and reception on the one or more bearers.

In some examples, continuing transmission and/or reception on the one or more bearers comprises maintaining one or more services on the one or more bearers.

In examples where the terminal node 110 releases the one or more bearers on receiving the DAPS handover configuration information 10, in case of fallback the terminal node 110 adds and/or configures and/or establishes the one or more bearers and resumes transmission and/or reception on the one or more bearers.

Examples of the disclosure provide technical benefits. For example, examples of the disclosure provide for an enhanced and/or improved DAPS handover procedure.

Examples of the disclosure provide uninterrupted fallback during a DAPS handover procedure in relation to one or more bearers to be released in relation to a target access node.

Examples of the disclosure provide for communication to continue during a DAPS handover procedure on one or more bearers to be released in relation to a target access node.

FIG. 3 illustrates an example of a method 300.

In examples, the method 300 can be performed by any suitable apparatus comprising any suitable means for performing the method 300.

In examples, the method 300 can be performed by a terminal node 110.

Method 300 comprises enabling dual active protocol stack, DAPS, handover, comprising performing, at least, the blocks illustrated in the example of FIG. 3.

At block 302, method 300 comprises receiving DAPS handover configuration information 10 comprising information 12 indicating one or more bearers that are to be released.

At block 304, method 300 comprises maintaining the one or more bearers during a random-access procedure with a target access node 120b.

Consequently, FIG. 3 illustrates a method 300 comprising:
enabling dual active protocol stack, DAPS, handover, comprising:
receiving DAPS handover configuration information 10 comprising information 12 indicating one or more bearers that are to be released; and
maintaining the one or more bearers during a random-access procedure with a target access node 120b.

FIG. 4 illustrates an example of a method 400.

In examples, the method 400 can be performed by any suitable apparatus comprising any suitable means for performing the method 400.

In examples, the method 400 can be performed by an access node 120a, which can be considered a source access node.

Method 400 comprises supporting dual active protocol stack, DAPS, handover comprising performing, at least, the blocks illustrated in the example of FIG. 4.

At block 402, method 400 comprises receiving DAPS handover configuration information 10 comprising information 12 indicating one or more bearers that are to be released.

At block 404, method 400 comprises maintaining the one or more bearers after receipt of the DAPS handover configuration information 10.

Consequently, FIG. 4 illustrates a method 400 comprising:
supporting dual active protocol stack, DAPS, handover, comprising:
receiving DAPS handover configuration information 10 comprising information 12 indicating one or more bearers that are to be released; and
maintaining the one or more bearers after receipt of the DAPS handover configuration information 10.

FIG. 5 illustrates an example of a method 500.

In examples, the method 500 can be performed by any suitable apparatus comprising any suitable means for performing the method 500.

In examples, the method 500 can be performed by an access node 120b, which can be considered a target access node.

Method 500 comprises supporting dual active protocol stack, DAPS, handover comprising performing, at least, the blocks illustrated in the example of FIG. 5.

At block 502, method 500 comprises receiving a DAPS handover request 18 comprising an indication 20 that delayed bearer release is to be used.

At block 504, method 500 comprises determining DAPS handover configuration information 10 comprising information 12 indicating one or more bearers that are to be released and an indication 14 that the one or more bearers are to be maintained during a random-access procedure between a terminal node 110 and a target access node 120b.

At block 506, method 500 comprises transmitting the DAPS handover configuration information 10.

Consequently, FIG. 5 illustrates a method 500 comprising:
supporting dual active protocol stack, DAPS, handover, comprising:
receiving a DAPS handover request 18 comprising an indication 20 that delayed bearer release is to be used;
determining DAPS handover configuration information 10 comprising information 12 indicating one or more bearers that are to be released and an indication 14 that the one or more bearers are to be maintained during a random-access procedure between a terminal node 110 and a target access node 120b; and transmitting the DAPS handover configuration information 10.

FIG. 6 shows an example of delayed bearer release.

In the example of FIG. 6 a terminal node 110, in the form of a UE, and two access nodes 120, a source node 120a and a target node 120b are represented by separate lines.

At block 602, the source node 120a transmits a handover request to the target node 120b.

At block 604 the target node 120b transmits a handover request acknowledgement to the source node 120a, the handover request acknowledgment comprising RRC-Reconfiguration with DAPS configuration and a list of bearers not admitted at the access node 120b.

After DAPS handover preparation with the target node 120b, the source node 120a identifies, from the handover acknowledgement message, that one or more bearers are not accepted at the target node 120b.

At block 606, the source node 120a decides that delayed release of bearers is to be used.

In the illustrated example, the source node 120a therefore maintains the one or more bearers

At block 608, the source node 120a transmits the RRC-Reconfiguration with DAPS configuration to the terminal node 110. The source node 110 includes a flag in the RRC Reconfiguration to indicate ‘RLC-Release-on-DAPS-switching’.

At block 610 the terminal node 110 creates a protocol stack instance for target protocol stack for the modified bearers.

At block 612 the terminal node 110 does not release the bearers indicated for release at the source protocol stack. The source node 120a and UE continue with the transmission/reception for the released bearers until the uplink switch for DAPS occurs, when random access is successfully completed.

At block 614, a random access procedure is successfully completed between the UE 110 and target node 120b and at block 616 the UE 110 releases the bearers marked for release.

In case of DAPS fallback, UE and network continue on the one or more bearers without any additional indication/changes at UE 110 and source node 120a.

FIG. 7 shows an example of delayed bearer release.

In the example of FIG. 7 a terminal node 110, in the form of a UE, and two access nodes 120, a source node 120a and a target node 120b are represented by separate lines.

At block 702, the source node 120a transmits a handover request to the target node 120b. The source node 120a includes a flag ‘delayed-DRB-Release-DAPS’ in the handover request message to the target node 120b.

At block 704 the target node 120b prepares RRC Reconfiguration containing the handover command and including flag ‘RLC-Release-on-DAPS-switching’.

The target node 120b can also confirm to the source node 120a in handover request acknowledgement message that the delayed release is configured towards UE in Handover-Request-ACK via another flag ‘delayed-DRB-Release-DAPS-Response’.

At block 706 the target node 120b transmits a handover request acknowledgement to the source node 120a, the handover request acknowledgment comprising RRC-Reconfiguration with DAPS configuration and a list of bearers not admitted at the access node 120b and flag indicating delayed bearer release.

In the illustrated example, the source node 120a maintains the one or more bearers.

In the examples of FIG. 7 blocks 708 to 716 are at least similar to blocks 608 to 616 and can be as described in relation to those blocks of FIG. 6 respectively.

Accordingly, in the example of FIG. 7, the source node 120a continues to schedule packets for release dedicated radio bearers until it receives handover success.

In some examples, the source node 120a may identify and inform the target node 120b about a list of bearers for which their corresponding user plane transmission/reception shall be continued by the source cell and UE until UL switch in case they are released by the target node 120b. In this case, “RLC-Release-on-DAPS-switching” that is generated by the target cell (or source cell) can be specific (have different value) for each bearer that is released. That is the UE may release bearer 1 if RLC-Release-on-DAPS-switching value of bearer 1 is 0 and delay the release of bearer 2 if RLC-Release-on-DAPS-switching value is of bearer 2 is 1.

In some examples, the 3GPP specifications mandate that the source and the UE to continue the user plane transmission/reception of the bearers to be released until the random access (UL switch) is successfully completed. Herein, the source cell does not have the option to enable/disable the feature of delayed release of the bearers.

In some examples, the UE stops the user plane transmission/reception of the bearers to be released until the UE receives a message from the target node to release the source protocol stack.

Examples of the disclosure provide technical benefits. For example, examples of the disclosure provide for improved data transmission and/or fallback during a DAPS handover procedure.

FIG. 8A illustrates an example of a controller 1130. The controller can be used in an apparatus such as a terminal node 110 and/or an access node 120, for example a source access node 120a and/or a target access node 120b. In examples, controller 1130 can be considered an apparatus 1130.

Implementation of a controller 1130 may be as controller circuitry. The controller 1130 may be implemented in hardware alone, have certain aspects in software including firmware alone or can be a combination of hardware and software (including firmware).

As illustrated in FIG. 8A the controller 1130 may be implemented using instructions that enable hardware functionality, for example, by using executable instructions of a computer program 1136 in a general-purpose or special-purpose processor 1132 that may be stored on a computer readable storage medium (disk, memory etc) to be executed by such a processor 1132.

The processor 1132 is configured to read from and write to the memory 1134. The processor 1132 may also comprise an output interface via which data and/or commands are output by the processor 1132 and an input interface via which data and/or commands are input to the processor 1132.

The memory 1134 stores a computer program 1136 comprising computer program instructions (computer program code) that controls the operation of the apparatus when loaded into the processor 1132. The computer program instructions, of the computer program 1136, provide the logic and routines that enables the apparatus to perform the methods illustrated in FIGS. 2 and/or 3 and/or 4 and/or 5 and/or 6 and/or 7.

The processor 1132 by reading the memory 1134 is able to load and execute the computer program 1136.

The apparatus therefore comprises:
at least one processor 1132; and
at least one memory 1134 including computer program code
the at least one memory 1134 and the computer program code configured to, with
the at least one processor 1132, cause the apparatus at least to perform:
enabling dual active protocol stack, DAPS, handover, comprising:
   receiving DAPS handover configuration information comprising information indicating one or more bearers that are to be released; and
   maintaining the one or more bearers during a random-access procedure with a target access node.

The apparatus therefore comprises:
at least one processor 1132; and
at least one memory 1134 including computer program code
the at least one memory 1134 and the computer program code configured to, with
the at least one processor 1132, cause the apparatus at least to perform: supporting dual active protocol stack, DAPS, handover, comprising:
   receiving DAPS handover configuration information comprising information indicating one or more bearers that are to be released; and
   maintaining the one or more bearers after receipt of the DAPS handover configuration information.

The apparatus therefore comprises:
at least one processor 1132; and
at least one memory 1134 including computer program code
the at least one memory 1134 and the computer program code configured to, with
the at least one processor 1132, cause the apparatus at least to perform:
supporting dual active protocol stack, DAPS, handover, comprising:
   receiving a DAPS handover request comprising an indication that delayed bearer release is to be used;
   determining DAPS handover configuration information comprising information indicating one or more bearers that are to be released and an indication that the one or more bearers are to be maintained during a random-access procedure between a terminal node and a target access node; and
   transmitting the DAPS handover configuration information.

As illustrated in FIG. 9A, the computer program 1136 may arrive at the apparatus via any suitable delivery mechanism 1162. The delivery mechanism 1162 may be, for example, a machine readable medium, a computer-readable medium, a non-transitory computer-readable storage medium, a computer program product, a memory device, a record medium such as a Compact Disc Read-Only Memory (CD-ROM) or a Digital Versatile Disc (DVD) or a solid state memory, an article of manufacture that comprises or tangibly embodies the computer program 1136. The delivery mechanism may be a signal configured to reliably transfer the computer program 1136. The apparatus may propagate or transmit the computer program 1136 as a computer data signal.

Computer program instructions for causing an apparatus to perform at least the following or for performing at least the following:
enabling dual active protocol stack, DAPS, handover, comprising:
   receiving DAPS handover configuration information comprising information indicating one or more bearers that are to be released; and
   maintaining the one or more bearers during a random-access procedure with a target access node.

Computer program instructions for causing an apparatus to perform at least the following or for performing at least the following:
supporting dual active protocol stack, DAPS, handover, comprising:
   receiving DAPS handover configuration information comprising information indicating one or more bearers that are to be released; and
   maintaining the one or more bearers after receipt of the DAPS handover configuration information.

Computer program instructions for causing an apparatus to perform at least the following or for performing at least the following:
supporting dual active protocol stack, DAPS, handover, comprising:
   receiving a DAPS handover request comprising an indication that delayed bearer release is to be used;
   determining DAPS handover configuration information comprising information indicating one or more bearers that are to be released and an indication that the one or more bearers are to be maintained during a random-access procedure between a terminal node and a target access node; and
   transmitting the DAPS handover configuration information.

The computer program instructions may be comprised in a computer program, a non-transitory computer readable medium, a computer program product, a machine readable medium. In some but not necessarily all examples, the computer program instructions may be distributed over more than one computer program.

Although the memory 1134 is illustrated as a single component/circuitry it may be implemented as one or more separate components/circuitry some or all of which may be integrated/removable and/or may provide permanent/semi-permanent/dynamic/cached storage.

In examples the memory 1134 comprises a random-access memory 1158 and a read only memory 1160. In examples the computer program 1136 can be stored in the read only memory 1158. See, for example, FIG. 9B

In some examples the memory 1134 can be split into random access memory 1158 and read only memory 1160.

Although the processor 1132 is illustrated as a single component/circuitry it may be implemented as one or more separate components/circuitry some or all of which may be integrated/removable. The processor 1132 may be a single core or multi-core processor.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term ‘circuitry’ may refer to one or more or all of the following:
(a) hardware-only circuitry implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions and (c) hardware circuit(s) and or processor(s), such as a microprocessor(s) or a portion of a microprocessor(s), that requires software (e.g. firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor and its (or their) accompanying software and/or firmware. The term circuitry also covers, for example and if applicable to the particular claim element, a baseband integrated circuit for a mobile device or a similar integrated circuit in a server, a cellular network device, or other computing or network device.

The blocks illustrated in the FIGS. 2 and/or 3 and/or 4 and/or 5 and/or 6 and/or 7 may represent steps in a method and/or sections of code in the computer program 1136. The illustration of a particular order to the blocks does not necessarily imply that there is a required or preferred order for the blocks and the order and arrangement of the block may be varied. Furthermore, it may be possible for some blocks to be omitted.

Where a structural feature has been described, it may be replaced by means for performing one or more of the functions of the structural feature whether that function or those functions are explicitly or implicitly described.

Thus, the apparatus can, in examples, comprise means for:
enabling dual active protocol stack, DAPS, handover, comprising:
   receiving DAPS handover configuration information comprising information indicating one or more bearers that are to be released; and
   maintaining the one or more bearers during a random-access procedure with a target access node.

Thus, the apparatus can, in examples, comprise means for:
supporting dual active protocol stack, DAPS, handover, comprising:
   receiving DAPS handover configuration information comprising information indicating one or more bearers that are to be released; and
   maintaining the one or more bearers after receipt of the DAPS handover configuration information.

Thus, the apparatus can, in examples, comprise means for:
supporting dual active protocol stack, DAPS, handover, comprising:
   receiving a DAPS handover request comprising an indication that delayed bearer release is to be used;
   determining DAPS handover configuration information comprising information indicating one or more bearers that are to be released and an indication that the one or more bearers are to be maintained during a random-access procedure between a terminal node and a target access node; and
   transmitting the DAPS handover configuration information.

In examples, an apparatus can comprise means for performing one or more methods, and/or at least part of one or more methods, as disclosed herein.

In examples, an apparatus can be configured to perform one or more methods, and/or at least part of one or more methods, as disclosed herein.

The above described examples find application as enabling components of: automotive systems; telecommunication systems; electronic systems including consumer electronic products; distributed computing systems; media systems for generating or rendering media content including audio, visual and audio visual content and mixed, mediated, virtual and/or augmented reality; personal systems including personal health systems or personal fitness systems; navigation systems; user interfaces also known as human machine interfaces; networks including cellular, non-cellular, and optical networks; ad-hoc networks; the internet; the internet of things; virtualized networks; and related software and services.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although examples have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

Although features have been described with reference to certain examples, those features may also be present in other examples whether described or not.

The term ‘a’ or ‘the’ is used in this document with an inclusive not an exclusive meaning. That is any reference to X comprising a/the Y indicates that X may comprise only one Y or may comprise more than one Y unless the context clearly indicates the contrary. If it is intended to use ‘a’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

Whilst endeavoring in the foregoing specification to draw attention to those features believed to be of importance it should be understood that the Applicant may seek protection via the claims in respect of any patentable feature or combination of features hereinbefore referred to and/or shown in the drawings whether or not emphasis has been placed thereon.

I/We claim:

1. An apparatus comprising
at least one processor; and
at least one memory including computer program code;
the at least one memory and the computer program code configured to, with the at least one processor, cause the apparatus to perform:
enabling dual active protocol stack, DAPS, handover, comprising:
receiving DAPS handover configuration information comprising information indicating one or more bearers that are to be released; and
maintaining the one or more bearers during a random-access procedure with a target access node.

2. An apparatus as claimed in claim 1, wherein the DAPS handover configuration information comprises an indication that the one or more bearers are to be maintained during the random-access procedure with the target access node.

3. An apparatus as claimed in claim 1, the at least one memory and the computer program code configured to, with the at least one processor, cause the apparatus to perform:
releasing the one or more bearers after the random-access procedure with the target access node is completed.

4. An apparatus as claimed in claim 3, wherein releasing the one or more bearers comprises releasing one or more internal bearer configurations and/or resources and/or stopping transmission and/or reception on the one or more bearers.

5. An apparatus as claimed in claim 1, wherein maintaining the one or more bearers comprises maintaining one or more internal bearer configurations and/or resources and/or receiving and/or transmitting on the one or more bearers.

6. An apparatus as claimed in claim 1, the at least one memory and the computer program code configured to, with the at least one processor, cause the apparatus to perform:
if the DAPS handover fails, continuing transmission and/or reception on the one or more bearers.

7. An apparatus as claimed in claim 6, wherein continuing transmission and/or reception on the one or more bearers comprises maintaining one or more services on the one or more bearers.

8-28. (canceled)

29. An apparatus comprising at least one processor; and
at least one memory including computer program code;
the at least one memory and the computer program code configured to, with the at least one processor, cause the apparatus to perform:
supporting dual active protocol stack, DAPS, handover, comprising:
receiving DAPS handover configuration information comprising information indicating one or more bearers that are to be released; and
maintaining the one or more bearers after receipt of the DAPS handover configuration information.

30. An apparatus as claimed in claim 29, the at least one memory and the computer program code configured to, with the at least one processor, cause the apparatus to perform:
maintaining the one or more bearers until an indication of DAPS handover success is received.

31. An apparatus as claimed in claim 29, the at least one memory and the computer program code configured to, with the at least one processor, cause the apparatus to perform:
receiving an indication of DAPS handover success; and
releasing the one or more bearers after receiving the indication.

32. An apparatus as claimed in claim 29, the at least one memory and the computer program code configured to, with the at least one processor, cause the apparatus to perform: determining that delayed bearer release is to be used during a DAPS handover procedure.

33. An apparatus as claimed in claim 29, the at least one memory and the computer program code configured to, with the at least one processor, cause the apparatus to perform:
transmitting a DAPS handover request to a target node, the handover request comprising an indication that delayed bearer release is to be used.

34. An apparatus as claimed in claim 29, wherein the DAPS handover configuration information comprises an indication that the one or more bearers are to be maintained during a random-access procedure between a terminal node and a target access node.

35. An apparatus as claimed in claim 29, wherein the DAPS handover configuration information is received in a handover request acknowledgment, wherein the handover request acknowledgement is received in response to a DAPS handover request.

36. An apparatus as claimed in claim 29, the at least one memory and the computer program code configured to, with the at least one processor, cause the apparatus to perform:
amending the DAPS handover configuration information to include an indication that the one or more bearers are to be maintained during a random-access procedure between a terminal node and a target access node.

37. An apparatus as claimed in claim 29, the at least one memory and the computer program code configured to, with the at least one processor, cause the apparatus to perform:
transmitting the DAPS handover configuration information to at least one terminal node.

38-64. (canceled)

65. An apparatus comprising
at least one processor; and
at least one memory including computer program code;
the at least one memory and the computer program code configured to, with the at least one processor, cause the apparatus to perform:
supporting dual active protocol stack, DAPS, handover, comprising:
receiving a DAPS handover request comprising an indication that delayed bearer release is to be used;
determining DAPS handover configuration information comprising information indicating one or more bearers that are to be released and an indication that the one or more bearers are to be maintained during a random-access procedure between a terminal node and a target access node; and
transmitting the DAPS handover configuration information.

66. An apparatus as claimed in claim 65, the at least one memory and the computer program code configured to, with the at least one processor, cause the apparatus to perform:
determining the one or more bearers that are to be released.

67. An apparatus as claimed in claim 65, the at least one memory and the computer program code configured to, with the at least one processor, cause the apparatus to perform:
transmitting an acknowledgement that DAPS handover configuration information is configured for delayed bearer release.

68-70. (canceled)

71. A computer program comprising instructions for causing an apparatus to perform:
supporting dual active protocol stack, DAPS, handover, comprising:
receiving a DAPS handover request comprising an indication that delayed bearer release is to be used;
determining DAPS handover configuration information comprising information indicating one or more bearers that are to be released and an indication that the one or more bearers are to be maintained during a random-access procedure between a terminal node and a target access node; and
transmitting the DAPS handover configuration information.

72. A computer program as claimed in claim 71, comprising instructions for causing an apparatus to perform:
determining the one or more bearers that are to be released.

73. A computer program as claimed in claim 71, comprising instructions for causing an apparatus to perform:
transmitting an acknowledgement that DAPS handover configuration information is configured for delayed bearer release.

74-76. (canceled)
